(19) United States
(12) Patent Application Publication
(10) Pub. No.: US 2002/0188868 A1
(43) Pub. Date: Dec. 12, 2002

(54) Method for protecting use of resources in a network

(76) Inventors: Kenneth C. Budka, Marlboro, NJ (US); Richard R. Reece, Littleton, CO (US); Steven E. Sommars, Wheaton, IL (US); Patric J. Walsh, Bloomingdate, IL (US)

Correspondence Address: HARNESS, DICKEY & PIERCE, P.L.C., P.O. BOX 8910, RESTON, VA, 20195, US

(21) Appl. No.: 09/878,230

(22) Filed: Jun. 12, 2001

(51) Int. Cl. G06F 11/30

(52) U.S. Cl. 713/201

(57) ABSTRACT

In the method for protecting use of resources in a network, a communication address request for a temporary communication address is received from user equipment; the communication address request includes an identifier of the user equipment. The communication address request is processed based on a failure count accessed using the identifier for the user equipment; the failure count indicating a number of times the user equipment has been denied registration.

### BACKGROUND OF THE INVENTION

1. Field of the Invention

The present invention relates to communication, and more particularly, to protecting the use of resources in a network.

2. Description of Related Art

Before a mobile station can gain access to a wireless data network, the mobile station must register. Similar processes can be required in wireless voice networks, wired line data networks, and other networks using secure links between user equipment and the network. For the purposes of example, the registration process in a wireless data network will be described.

By registering, a mobile station informs the wireless data network of its current location, thereby allowing the wireless data network to forward packets bound for the mobile station to the correct base station serving the communication needs of the mobile station. In addition, registration serves as a first line of defense against fraudulent network usage. During registration, a mobile station sends encrypted messages to the wireless data network containing a mobile station's “credentials.” Mobile stations presenting invalid credentials will be denied access to the wireless data network. FIG. 1 gives an overview of the messages typically exchanged during registration. As shown, a mobile station 10 sends a request for a temporary link layer address. The mobile station 10 includes its Equipment Identifier (EID) in the communication address message. The EID is a unique number assigned by the manufacturer of the mobile station 10 (e.g., electronic serial number (ESN)). The request is received by a base station 12 and forwarded to a wireless data router 14.

The wireless data router 12 assigns a temporary link layer address to the mobile station 10, and creates and initializes data structures used by wireless data protocols. A message containing the mobile's EID and the assigned link layer address is sent to the mobile station 10 by the wireless data router 14.

Wireless data networks encrypt transmissions over the airlink. Encryption key management is typically based on the Diffie-Hellman Electronic Key exchange procedure (e.g., Cellular Digital Packet Data networks use this procedure.) The Diffie-Hellman Electronic Key exchange procedure requires the network to generate a triplet (a, p, a^{y}mod p). The quantity a denotes an integer known to all mobiles using the network, p denotes a prime number known to all users using the network, and y denotes a secret random integer known only to the wireless data router 14. The wireless data router 14 sends this triplet to the mobile system. The mobile station 10 performs its half of the Diffie-Hellman Electronic Key Exchange procedure by generating a secret random number x, and transmitting the quantity (a^{x}mod p) to the wireless data router 14. An encryption key is created by the mobile station 10 and the wireless data router 14 as the product (a^{y}mod p)(a^{x}mod p).

The mobile station 10 sends its network layer address (e.g., IP address) along with its “credentials,” a shared secret known by only the network and the mobile station 10. The message containing this information is encrypted using the encryption key. The wireless data network 14 sends a query to a authentication server 16. The authentication server 16 contains the current values of mobile station's credentials. The query contains the network layer address of the mobile station 10 as well as the credentials sent by the mobile station 10. The authentication server 16 checks the credentials against those stored in its database. If the credentials match, the authentication server 16 tells the wireless data router 14 to grant the mobile station 10 access to the network. New credentials may be generated and sent to the wireless data router 14 in the authentication response message. The wireless data router 14 informs the mobile station 10 of the result of its registration request. If the registration is successful the mobile station 10 is allowed access to the network. If new credentials were generated by the authentication server 16, the new credentials are also included in the registration response message.

Recent Cellular Digital Packet Data network usage statistics show a large fraction of mobile registration requests are denied because mobile stations are presenting invalid credentials during registration. Furthermore, as soon as these so-called “rogue mobiles” are denied registration, they immediately attempt to register again. Mobile stations may also be denied registration for other reasons such as exceeding usage limits or providing a network layer address that is not known.

Mobile registration consumes a large amount of network resources. Encryption key generation is an extremely CPU-intensive process as is the initialization of data structures used by the wireless data router. As a result, registration attempts from rogue mobiles can generate extremely high CPU loads on the wireless data routers. Heavy CPU loads can prevent mobile stations with valid credentials from being able to register with the network, effectively denying them service.

### SUMMARY OF THE INVENTION

According to the present invention, the network maintains a database of identifiers for users' equipment that were recently denied service because they failed registration. The database will contain a list of identifiers and an associated count of registration failures for each user equipment (e.g., a mobile station). When user equipment sends a request for a communication address, for example, a temporary link layer address, the identifier sent by the user equipment in the request is checked against this “rogue” database. If the identifier of the user equipment appears in the database and the count of failed registrations has reached a predefined limit, the registration failure threshold, the network simply ignores the request. If the identifier of the user equipment appears in the database but the failed registration count has not reached the registration failure threshold, or the identifier of the user equipment is not in the database, a communication address is assigned and the registration process is allowed to proceed.

If a registration request is denied, the network updates the database. If the user equipment is not in the database, the network enters the identifier of the rogue equipment and sets the registration failure count to one. If the user equipment is already in the rogue database the network simply increments the registration failure count by one. The registration result message is then forwarded to the user equipment. If upon incrementing the registration failure count the user equipment has reached the registration failure threshold, a ZAP command is sent to the user equipment instructing it to disable its transmitter for a period equal to a predefined value, the leak delay. If the user equipment obeys the ZAP command then even the overhead associated with processing the link layer address request is avoided in addition to saving the airlink bandwidth.

Periodically, as defined by the leak delay, the registration failure count for each user equipment in the database is decremented by 1. When the user equipment's registration failure count is decremented to 0, it is removed from the database. When the registration failure count has decremented below the registration failure threshold, the network will accept another registration.

### BRIEF DESCRIPTION OF THE DRAWINGS

The present invention will become more fully understood from the detailed description given hereinbelow and the accompanying drawings, which are given by way of illustration only, and thus are not limitative of the present invention, and wherein:

FIG. 1 illustrates an overview of the messages typically exchanged during registration of a mobile station;

FIG. 2 illustrates the processing performed by the wireless data router when the mobile station initiates the registration process by requesting a temporary link layer address; and

FIG. 3 illustrates the processing performed by the wireless data router in response to the authentication response from the authentication server during the registration process.

### DETAILED DESCRIPTION OF THE PREFERRED EMBODIMENTS

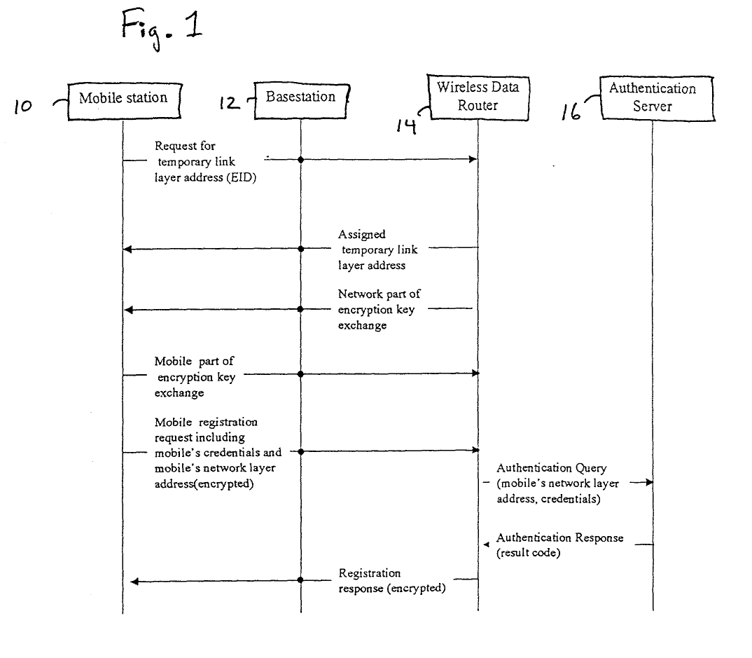

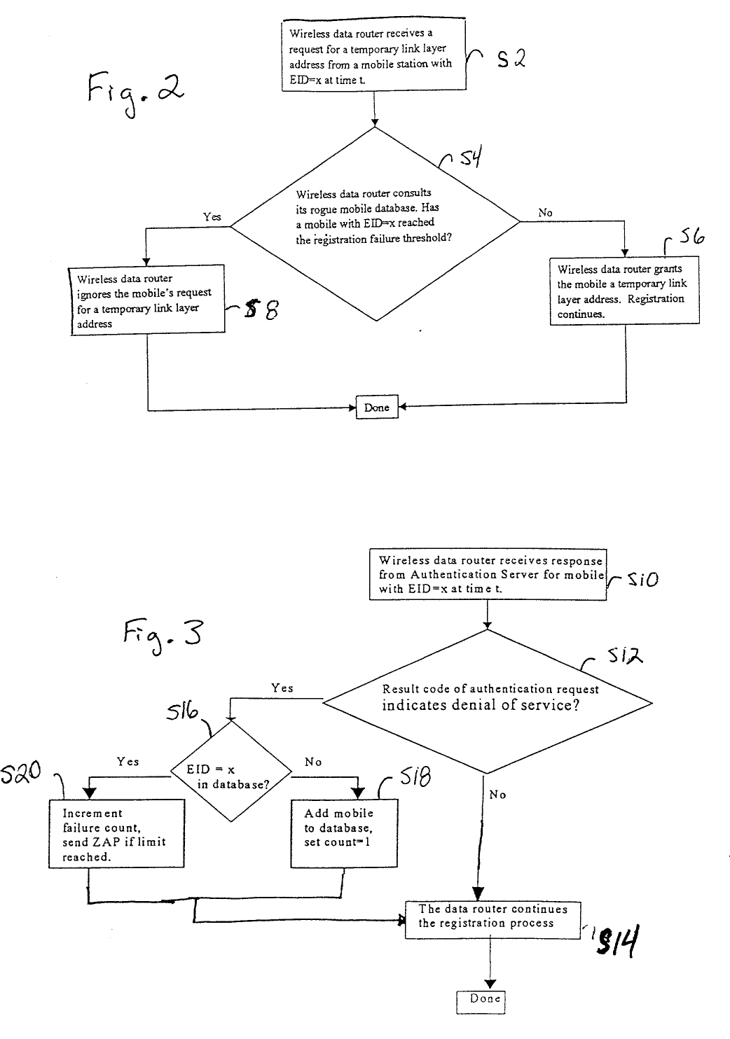

The method of protecting the use of resources in a network will be described as applied to the wireless data system shown in FIG. 1, and will be described with reference to the flow charts illustrated in FIGS. 2-3. However, it will be understood from the following disclosure that the method is applicable to wireless voice networks, wired line data networks, and any other networks using secure links between user equipment and the network.

FIG. 2 illustrates the processing performed by the wireless data router 14 when the mobile station 10 initiates the registration process by requesting a temporary link layer address. As shown, in step S2 the wireless data router 14 receives the request for the temporary link layer address from the mobile station 10. Along with the request, the mobile station 10 sends its equipment identifier (EID).

Next, in step S4, the wireless data router 14 accesses a database stored therein that contains a list of rogue mobiles. A rogue mobile is a mobile station that has failed authentication. Mobile stations are identified in the list by their EID. Accordingly, the wireless data router 14 determines if the EID of the mobile station 10 is in the rogue mobile list. If not, processing proceeds to step S6. If the EID is in the rogue mobile list, the wireless data router 14 obtains the registration failure count for the mobile station 10. In the rogue mobile list, a registration failure count is stored in association with each EID. The registration failure count indicates the number of times the associated mobile station has failed to complete the registration process. If the registration failure count for the mobile station 10 is less than a predetermined registration failure threshold, then processing proceeds to step S6.

In step S6, the wireless data router 14 grants the mobile station 10 a temporary link layer address, and the registration process continues as described above with respect to FIG. 1. However, in step S4, if the registration failure count equals or exceeds the registration failure threshold, processing proceeds to step S8. In step S8, the wireless data router 14 ignores the mobile station's request for a temporary link layer address. Consequently, the resources of the wireless data router 14 as well as the other parts of the wireless system required to continue the registration process are not used, thus preventing use of those resources.

If the registration process continues, then as shown in FIG. 1, the authentication server 16 will return an authentication response as to whether the mobile station 10 is a valid mobile. This begins the processing performed by the wireless data router 14 as illustrated in the flow chart in FIG. 3 (see step S10). In step S12, the wireless data router 14 determines if the authentication response is a denial of service. If not, then in step S14, the wireless data router 14 continues the registration process. However, if the authentication response is a denial of service, then in step S16 the wireless data router 14 determines if the mobile station 10 is in the rogue mobile list. Specifically, the wireless data router 14 determines if the EID of the mobile station 10 is in the rogue mobile list. If not on the list, the wireless data router 14 adds the EID of the mobile station 10 to the list and associates a registration failure count of 1 with the EID in step S18.

If in step S16 the wireless data router 14 determines that the mobile station 10 is on the rogue mobile list, then in step S20 the wireless data router 14 increments the registration failure count for the mobile station 10 by one. Also, the wireless data router 14 determines if the incremented registration failure count equals or exceeds the registration failure threshold. If the threshold has not been reached, then processing proceeds to step S14. However, if the threshold has been reached, then the wireless data router 14 sends a zap command to the mobile station 10. The zap command instructs the mobile station 10 to disable its transmitter for a predetermined period of time called the leak delay. If the mobile station 10 obeys the zap command, then even the overhead associated with processing the link layer address request is avoided in addition to saving the airlink bandwidth.

Periodically, as defined by the leak delay, the registration failure count for each mobile in the database is decremented by 1. When a mobile station's registration failure count is decremented to 0, it is removed from the database. When the registration failure count has decremented below the mobile station registration failure threshold, the wireless data router 14 will accept another registration from this mobile.

As described, the database is automatically populated and depopulated requiring no manual intervention. When a mobile registration fails, that EID is placed into the database. More than registration failure threshold registration failures during a period of time equal to the leak delay will result in the mobile being treated as a “true rogue”, where link layer address requests will be ignored. The advantage here is that temporary network failures will not unfairly penalize a mobile station. It takes a persistent series of registration failures before the mobile station is tagged a “true rogue.”

Using this approach, rogue mobiles are prevented from wasting significant amounts of wireless data router and authentication server capacity, allowing more of the wireless data network's resources to be used to serve mobiles with valid credentials.

The invention being thus described, it will be obvious that the same may be varied in many ways. For example, the initial failure count is not limited to a value of 1, the increment of the failure count is not limited to 1, and the decrement of the failure count is not limited to 1. As another example, implementation of the method according to the present invention is not limited to implementation by the wireless data router 14 or by corresponding elements in other types of networks. For instance, in a wireless voice network, the method could be implemented by either a mobile switching center or a base station. Such variations are not to be regarded as a departure from the spirit and scope of the invention, and all such modifications as would be obvious to one skilled in the art are intended to be included within the scope of the following claims.

We claim:

1. A method for protecting use of resources in network, comprising:
receiving a communication address request for a temporary communication address from user equipment, the communication address request including an identifier of the user equipment;
processing the communication address request based on a failure count accessed using the identifier for the user equipment, the failure count indicating a number of times the user equipment has been denied registration.

2. The method of claim 2, wherein the processing step comprises:
accessing the failure count for the user equipment based on the identifier; and
ignoring the communication address request if the failure count exceeds a predetermined threshold.

3. The method of claim 2, wherein the processing step comprises:
continuing with a registration process if the failure count does not exceed a predetermined threshold.

4. The method of claim 4, further comprising:
incrementing the failure count for the user equipment if during the registration process the user equipment is not authenticated.

5. The method of claim 4, further comprising:
sending a message to the user equipment instructing the user equipment not to attempt registration for a predetermined period of time if the incremented failure count equals or exceeds the predetermined threshold.

6. The method of claim 5, wherein the user equipment is a mobile station in one of a wireless data network and a wireless voice network.

7. The method of claim 5, further comprising:
decrementing the failure count after a predetermined period of time has elapsed from the sending step.

8. The method of claim 4, further comprising:
decrementing the failure count after a predetermined period of time.

9. The method of claim 3, wherein the continuing step continues the registration process if a failure count does not exist for the user equipment.

10. The method of claim 9, further comprising:
incrementing the failure count for the user equipment if a failure count was accessed and if during the registration process the user equipment is not authenticated; and
initializing a failure count for the user equipment to an initial value if a failure count does not exist for the user equipment and if during the registration process the user equipment is not authenticated.

11. The method of claim 10, wherein the user equipment is a mobile station in one of a wireless data network and a wireless voice network.

12. The method of claim 1, further comprising:
incrementing the failure count for the user equipment if during the registration process the user equipment is not authenticated.

13. The method of claim 12, further comprising:
sending a message to the user equipment instructing the user equipment not to attempt registration for a predetermined period of time if the incremented failure count equals or exceeds the predetermined threshold.

14. The method of claim 13, further comprising:
decrementing the failure count after a predetermined period of time has elapsed from the sending step.

15. The method of claim 12, further comprising:
decrementing the failure count after a predetermined period of time.

16. The method of claim 1, wherein the processing step continues a registration process if a failure count does not exist for the user equipment.

17. The method of claim 16, further comprising:
incrementing the failure count for the user equipment if a failure count was accessed and if during the registration process the user equipment is not authenticated; and
initializing a failure count for the user equipment to an initial value if a failure count does not exist for the user equipment and if during the registration process the user equipment is not authenticated.

18. The method of claim 1, wherein the user equipment is a mobile station in one of a wireless data network and a wireless voice network.
